(19) United States
(12) Patent Application Publication
(10) Pub. No.: US 2009/0035661 A1
(43) Pub. Date: Feb. 5, 2009

(54) SYNTHESIS OF CATHODE ACTIVE MATERIALS

(76) Inventors: Jeffrey Swoyer, Port Washington, WI (US); M. Yazid Saidi, Henderson, NV (US); Titus Faulkner, Las Vegas, NV (US)

Correspondence Address: VALENCE TECHNOLOGY, INC., 1889 E. MAULE AVENUE, SUITE A, LAS VEGAS, NV, 89119, US

(21) Appl. No.: 11/832,502

(22) Filed: Aug. 1, 2007

(51) Int. Cl. H01M 4/58; C01G 31/00

(52) U.S. Cl. 429/231.5; 423/62

(57) ABSTRACT

The present invention relates to a method for preparing a lithium vanadium phosphate material comprising forming a aqueous slurry (in which some of the components are at least partially dissolved) comprising a polymeric material, an acidic phosphate anion source, a lithium compound, V₂O₅ and a source of carbon; wet blending said slurry, spray drying said slurry to form a precursor composition; and heating said precursor composition to produce a lithium vanadium phosphate. In one embodiment the present invention relates to a method for preparing a lithium vanadium phosphate which comprises reacting vanadium pentoxide (V₂O₅) with phosphoric acid (H₃PO₄) to form a partially dissolved slurry; then mixing with an aqueous solution containing lithium hydroxide; adding a polymeric material and a source of carbon to form a slurry; wet blending said slurry; spray drying said slurry to form a precursor composition; and heating said precursor composition for a time and at a temperature sufficient to produce a lithium vanadium phosphate compound. In an alternative embodiment the present invention relates to a method for preparing a lithium vanadium phosphate which comprises preparing an aqueous solution of lithium hydroxide; partially dissolving vanadium pentoxide in said aqueous solution; adding phosphoric acid to the aqueous solution; adding a polymeric material and a source of carbon to the solution containing vanadium pentoxide to form a slurry; spray drying said slurry to form a precursor composition; and heating said precursor composition for a time and at a temperature sufficient to form a lithium vanadium phosphate. The electrochemically active lithium vanadium phosphate so produced is useful in making electrodes and batteries.

### FIELD OF THE INVENTION

The present invention relates to the synthesis of electroactive lithium vanadium phosphate materials for use in batteries, more specifically to cathode active materials for use in lithium ion batteries.

### BACKGROUND OF THE INVENTION

The proliferation of portable electronic devices such as cell phones and laptop computers has lead to an increased demand for high capacity, long endurance light weight batteries. Because of this, alkali metal batteries, especially lithium ion batteries, have become a useful and desirable energy source. Lithium metal, sodium metal, and magnesium metal batteries are well known and desirable energy sources.

By way of example and generally speaking, lithium batteries are prepared from one or more lithium electrochemical cells containing electrochemically active (electroactive) materials. Such cells typically include, at least, a negative electrode (anode), a positive electrode (cathode), and an electrolyte for facilitating movement of ionic charge carriers between the negative and positive electrode. As the cell is charged, lithium ions are transferred from the positive electrode to the electrolyte and, concurrently from the electrolyte to the negative electrode. During discharge, the lithium ions are transferred from the negative electrode to the electrolyte and, concurrently from the electrolyte back to the positive electrode. Thus with each charge/discharge cycle the lithium ions are transported between the electrodes (anode and cathode). Such rechargeable batteries are called rechargeable lithium ion batteries or rocking chair batteries.

The electrodes of such batteries generally include an electrochemically active material having a crystal lattice structure or framework from which ions, such as lithium ions, can be extracted and subsequently reinserted and/or permit ions such as lithium ions to be inserted or intercalated and subsequently extracted. Recently, a class of transition metal phosphates and mixed metal phosphates have been developed, which have such a crystal lattice structure. These transition metal phosphates are insertion based compounds like their oxide based counterparts. The transition metal phosphates and mixed metal phosphates allow great flexibility in the design of lithium ion batteries.

Recently, three-dimensional structured compounds comprising polyanions such as (SO₄)ⁿ⁻, (PO₄)ⁿ⁻, (AsO₄)ⁿ⁻, and the like, have been proposed as viable alternatives to oxide based electrode materials such as LiMₓO_{y}. A class of such materials is disclosed in U.S. Pat. No. 6,528,033 B1 (Barker et al.) The compounds therein are of the general formula LiₐMI_{b}MII_{c}(PO₄)_{d} wherein MI and MII are the same or different. MI is a metal selected from the group consisting of Fe, Co, Ni, Mn, Cu, V, Sn, Ti, Cr and mixtures thereof. MII is optionally present, but when present is selected from the group consisting of Mg, Ca, Zn, Sr, Pb, Cd, Sn, Ba, Be, and mixtures thereof. An example of such polyanion based material includes the NASICON compounds of the nominal general formula such as Li₃V₂(PO₄)₃ (LVP or lithium vanadium phosphate), and the like.

Although these compounds find use as electrochemically active materials useful for producing electrodes these materials are not always economical to produce and due to the chemical characteristics of the starting materials sometimes involve extensive processing to produce such compounds. The present invention provides an economical, reproducible and efficient method for producing lithium vanadium phosphate with good electrochemical properties.

### SUMMARY OF THE INVENTION

The present invention relates to a method for preparing a lithium vanadium phosphate material comprising forming a aqueous slurry (in which some of the components are at least partially dissolved) comprising a polymeric material, an acidic phosphate anion source, a lithium compound, V₂O₅ and a source of carbon; wet blending said slurry, spray drying said slurry to form a precursor composition; and heating said precursor composition to produce a lithium vanadium phosphate. In one embodiment the present invention relates to a method for preparing a lithium vanadium phosphate which comprises reacting vanadium pentoxide (V₂O₅) with phosphoric acid (H₃PO₄) to form a partially dissolved slurry; then mixing with an aqueous solution containing lithium hydroxide; adding a polymeric material and a source of carbon to form a slurry; wet blending said slurry; spray drying said slurry to form a precursor composition; and heating said precursor composition for a time and at a temperature sufficient to produce a lithium vanadium phosphate compound. In an alternative embodiment the present invention relates to a method for preparing a lithium vanadium phosphate which comprises preparing an aqueous solution of lithium hydroxide; partially dissolving vanadium pentoxide in said aqueous solution; adding phosphoric acid to the aqueous solution; adding a polymeric material and a source of carbon to the solution containing vanadium pentoxide to form a slurry; spray drying said slurry to form a precursor composition; and heating said precursor composition for a time and at a temperature sufficient to form a lithium vanadium phosphate. The electrochemically active lithium vanadium phosphate so produced is useful in making electrodes and batteries.

### BRIEF DESCRIPTION OF THE DRAWINGS

FIG. 1 shows the capacity data for the lithium vanadium phosphate produced by the method of the present invention using the process described in Example 6.

### DETAILED DESCRIPTION

The present invention relates to methods for preparing an electroactive lithium vanadium phosphate of the nominal general formula Li₃V₂(PO₄)₃ In another embodiment the present invention relates to electrodes produced from such electroactive materials and to batteries which contain such electrodes.

Metal phosphates, and mixed metal phosphates and in particular lithiated metal and mixed metal phosphates have recently been introduced as electrode active materials for ion batteries and in particular lithium ion batteries. These metal phosphates and mixed metal phosphates are insertion based compounds. What is meant by insertion based is that such materials have a crystal lattice structure or framework from which ions, and in particular lithium ions, can be extracted and subsequently reinserted and/or permit ions to be inserted and subsequently extracted.

The transition metal phosphates allow for great flexibility in the design of batteries, especially lithium ion batteries. Simply by changing the identity of the transition metal allows for regulation of voltage and specific capacity of the active materials. Examples of such transition metal phosphate cathode materials include such compounds of the nominal general formulae LiFePO₄, Li₃V₂(PO₄)₃ and LiFe₁₋ₓMgₓPO₄ as disclosed in U.S. Pat. No. 6,528,033 B1 (Barker et al, hereinafter referred to as the '033 patent) issued Mar. 4, 2003.

A class of compounds having the general formula LiₐMI_{b}MII_{c}(PO₄)_{d} wherein MI and MII are the same or different are disclosed in U.S. Pat. No. 6,528,003 B1 (Barker et al.). MI is a metal selected from the group consisting of Fe, Co, Ni, Mn, Cu, V, Sn, Ti, Pb, Si, Cr and mixtures thereof. MII is optionally present, but when present is selected from the group consisting of Mg, Ca, Zn, Sr, Pb, Cd, Sn, Ba, Be, and mixtures thereof.

It is also disclosed in U.S. Pat. No. 6,528,033 B1 that Li₃V₂(PO₄)₃ (lithium vanadium phosphate) can be prepared by ball milling V₂)₅, Li₂CO₃, (NH₄)₂HPO₄ and carbon, and then pelletizing the resulting powder. The pellet is then heated to 300° C. to remove the NH₃. The pellet is then powderized and repelletized. The new pellet is then heated at 850° C. for 8 hours to produce the desired electrochemically active product.

It has been found that when making lithium vanadium phosphate by the method of the '033 patent that problems result from the dry ball mixing method. The dry ball-mill mixing method on a larger production scale sometimes results in an incomplete reaction of the starting materials. When the incomplete reaction occurs and the product so produced is used in a cell it produces a cell with poor cycle performance. The method on a large scale also resulted in poor reproducibility of the product formed.

Additionally, it has been found that when lithium vanadium phosphate, prepared using the methods of the '033 patent on a larger scale, is used in the preparation of phosphate cathodes it results in phosphate cathodes with high resistivity. The lithium vanadium phosphate powders produced by the method of the '033 patent on a large scale also exhibit a low tap density.

Previous methods for producing lithium vanadium phosphate utilized insoluble vanadium compounds either mixed in the dry state or mixed in aqueous solution with other precursors that may or may not have been soluble. Unless the dry mixing method was done with very high shear for a long period of time, it tended to leave traces of precursor in the final product. Both of these mixing methods required that the insoluble vanadium precursor be milled to a small particle size in order to overcome diffusion limitations during synthesis. Calcination of the precursor mix using insoluble vanadium tended to require at least 8 hours at 900° C. to get complete conversion.

It has now surprisingly been found that lithium vanadium phosphate can be prepared in a beneficial manner to produce materials with high electronic conductivity and an excellent cycle life with superior reversible capacity. The present invention is beneficial over previously disclosed processes in that it reduces mixing time, improves homogeneity of the precursor mixture, it reduces calcinations time and results in improved performance of the lithium vanadium phosphate as a lithium-ion cathode material. V₂O₅ is somewhat soluble in acidic and basic aqueous solutions. Lithium salts tend to be basic, while phosphate ion can be added via a phosphate acid or via a phosphate base. By carefully selecting the precursor salts for solubility and pH, and by selecting the right order of addition, it is possible to use an acidic or alkaline salt of phosphate or lithium to cause the dissolution of part or all of the V₂O₅ during the mixing process. This results in a more homogeneous precursor mixture.

A more homogeneous precursor mixture will tend to reduce the required temperature and time to obtain complete conversion of the precursors. This is desirable because it increases the amount of active phase in the product but more importantly reduces the amount of residual precursors in the product. In particular it eliminates the presence of V₂O₃, which is a poison for lithium ion battery cathode materials.

In one embodiment of the invention the lithium vanadium phosphate is produced by a wet blend method. The process comprises forming an aqueous mixture comprising H₂O, a polymeric material, a phosphate anion source, a lithium compound, V₂O₅ and a source of carbon. The aqueous mixture is then wet blended and then spray dried to form a precursor composition. The precursor composition is optionally ball milled and then pelletized. The precursor composition or pelletized precursor composition is then heated or calcined to produce the lithium vanadium phosphate product.

In one preferred embodiment the present invention relates to a method for preparing a lithium vanadium phosphate material which comprises reacting vanadium pentoxide (V₂O₅) with an acidic phosphate solution, for example phosphoric acid (H₃PO₄) to form a slurry. Said slurry is then mixed with a solution comprising water and a basic lithium compound such as lithium hydroxide (LiOH) to form a second slurry. A polymeric material and a source of carbon are added to said second slurry to form a third slurry. The third slurry is wet blended and then spray dried to form a precursor composition. The precursor composition is then optionally ball milled and pelletized. The precursor composition or pelletized precursor composition is then heated at a time and temperature sufficient to produce a lithium vanadium phosphate material.

In an alternate preferred embodiment the present invention relates to a method for preparing a lithium vanadium phosphate material which comprises preparing an aqueous solution of lithium hydroxide. Vanadium pentoxide is then partially dissolved in said aqueous solution. Phosphoric acid (H₃PO₄) is the added to the aqueous solution to form a neutralized solution. A polymeric material and a source of carbon are added to the neutralized solution to form a slurry. The slurry is wet blended and then spray dried to form a precursor composition. The precursor composition is then optionally ball milled and pelletized. The precursor composition or pelletized precursor composition is then heated to produce a lithium vanadium phosphate material.

In another preferred embodiment LiOH.H₂O is reacted with H₃PO₄ (solvent, polyanion source) to produce either LiH₂PO₄ or Li₃PO₄. V₂O₅ (metal source), carbon (or carbon containing organic material) and a polymeric material are then added to form a slurry. The slurry is mixed and then spray dried. The resulting essentially dried mixture is ball milled and then optionally pelletized. The dried mixture or pellet is then heated at a temperature and for a time sufficient to produce an electroactive lithium vanadium phosphate material.

The vanadium pentoxide is made partially or completely soluble in water-based solutions by raising or lowering the pH from neutral. This allows for a uniform precursor mixture that provides faster or lower temperature synthesis of lithium vanadium phosphate materials. In one embodiment the V₂O₅ is added to H₃PO₄ first and then mixed with a solution of LiOH in water. In another embodiment the V₂O₅ is reacted with LiOH.H₂O and then neutralized by addition of and acid such as H₃PO₄.

Without being limited hereby, it is believed that the polymeric material acts as a phase separation inhibitor during drying, heating and firing. In addition when used as such the carbon residue from the polymeric material acts as an electron conductivity promoter in the final products. The polymeric material additionally serves as a mix aid during the process by holding the reactants tightly together which produces a highly condensed products that have a higher tap density than materials made by the method of the '033 patent.

The carbon used can be an elemental carbon, preferably in particulate form such as graphites, amorphous carbon, carbon blacks and the like. In another aspect the carbon can be provided by an organic precursor material, or by a mixture of elemental carbon and an organic precursor material. By organic precursor material is meant a material made up of carbon, oxygen and hydrogen, that is capable of forming a decomposition product that contains carbon. Examples of such organic precursor materials include, but are not limited to, coke, organic hydrocarbons, alcohols, esters, ketones, aldehydes, carboxylic acids, ethers, sugars, other carbohydrates, polymers and the like. The carbon or organic precursor material is added in an amount to yield total carbon residue from about 0.1 weight percent to about 30 weight percent, preferably from about 1 weight percent to about 12 weight percent and more preferably from about 2 weight percent to about 12 weight percent. In one preferred product the weight percent is about 3.5%.

The carbon remaining in the reaction product functions as a conductive constituent in the ultimate electrode or cathode formulation. This is an advantage since such remaining carbon is very intimately mixed with the reaction product material.

In a preferred embodiment of the invention the solvent used is water and in particular deionized water. However, it would be apparent to one skilled in the art that any organic solvent would be useful herein wherein said solvent did not adversely affect the reaction to produce the desired product. Such solvents are preferably volatile and include, but are not limited to, deionized water, water, dimethylsulfoxide (DMSO), N-methylpyrrolidinone (NMP), propylene carbonate (PC), ethylene carbonate (EC), dimethylformamide (DMF), dimethyl ether (DME), tetrahydrofuran (THF), butyrolactone (BL) and the like. Preferably the solvent should have a boiling point in the range from about 25° C. to about 300° C.

The polymeric material is an organic substance preferably composed of carbon, oxygen and hydrogen, with amounts of other elements in quantity low enough to avoid interference with the synthesis of the metal polyanion or mixed metal polyanion and to avoid interference with the operation of the metal polyanion or mixed metal polyanion when used in a cathode. The polymer can be in liquid or solid form. The presence and effectiveness of the conductive network can be detected using powder resistivity measurements. Such measurements, in general, have indicated a high resistivity for lithium metal phosphates produced by the method of the '033 patent and a more desirable low resistivity for the lithium metal phosphates produced by the process of the present invention.

Powder resistivity measures the resistivity of composite materials in powder form. In the case of composite materials that are comprised primarily of insulating powders with small amounts of conductive materials, the resistivity of the composite will be governed by the amount of conductive material present and its pattern of distribution throughout the composite. In theory, without being limited thereby, it is believed that the optimal distribution of conductive material, for reducing the resistivity of a composite material is a network, wherein the conductive material forms continuous current paths or series of current paths throughout the composite material. In theory, without being limited thereby, the polymeric material as used in the process of the present invention, upon heating produces such current paths to form a conductive network throughout the powders composed of metal polyanions and mixed metal polyanions. With such a conductive network current can flow throughout the composite materials and resistivity of the composite is minimized.

In a preferred embodiment of the invention the polymeric material is poly(oxyalkylene) ether and more preferably is polyethylene oxide (PEO) or polyethylene glycol (PEG) or mixtures thereof. However, it would be apparent to one with skill in the art that other polymeric materials would be useful in the methods of the present invention. For example the polymeric material may include without limitation, carboxy methyl cellulose (CMC), ethyl hydroxyl ethyl cellulose (EHEC), polyolefins such as polyethylene and polypropylene, butadiene polymers, isoprene polymers, vinyl alcohol polymers, furfuryl alcohol polymers, styrene polymers including polystyrene, polystyrene-polybutadiene and the like, divinylbenzene polymers, naphthalene polymers, phenol condensation products including those obtained by reaction with aldehyde, polyacrylonitrile, polyvinyl acetate, as well as cellulose, starch and esters and ethers of those described above.

Preferably the polymeric material is compatible with the operation of the metal polyanion or mixed metal polyanion when used as a cathode active material in a cell. It is therefore preferred that residual amounts of the polymeric material will not interfere with the operation of the cell. Preferred polymers include polyethylene oxide, polyethylene, polyethylene glycol, carboxymethyl cellulose, ethyl hydroxyl ethyl cellulose and polypropylene. Polyethylene oxide is one preferred polymer in view of its known use as an electrolyte in lithium polymer batteries.

Phosphate ion sources include but are not limited to phosphoric acid and other phosphate containing anions in combination with desirable or volatile cations. Phosphoric acid sources are preferred Sources containing both an alkali metal and a phosphate can serve as both an alkali metal source and a phosphate source. The source of Li ions include LiOH and the like. The preferred Li ion source is LiOH.

The term milling as used herein often times specifically refers to ball milling. However, it is understood by those skilled in the art, that the term as used herein and in the claims can encompass processes similar to ball milling which would be recognized by those with skill in the art. For instance, the starting materials can be blended together, put in a commercially available muller and then the materials can be mulled. Alternatively, the starting materials can be mixed by high shear and/or using a pebble mill to mix the materials in a slurry form.

The wet blending of the slurry can be completed in about 1 minute to about 10 hours and preferably from about 1 hour to about 5 hours. One skilled in the art will recognize that stirring times can vary depending on factors such as temperature and size of the reaction vessel and amounts and choice of starting materials. The stirring times can be determined by one skilled in the art based on the guidelines given herein and choice of reaction conditions and the sequence that the starting materials are added to the slurry.

The slurry, containing the solvent, the polymeric material, a source of carbon, a lithium compound and V₂O₅ is spray dried using conventional spray drying equipment and methods. The slurry is spray dried by atomizing the slurry to form droplets and contacting the droplets with a stream of gas at a temperature sufficient to evaporate at least a major portion of the solvent used in the slurry. In one embodiment air can be used to dry the slurries of the invention. In other embodiments, it may be preferable to use a less oxidizing or an inert gas or a gas mixture. Spray drying produces a powdered, essentially dry precursor composition.

Spray drying is preferably conducted using a variety of methods that cause atomization, including rotary atomizers, pressure nozzles, and air (or two-fluid) atomizers. The slurry is thereby dispersed into fine droplets. It is dried by a relatively large volume of hot gases sufficient to evaporate the volatile solvent, thereby providing very fine particles of a powdered precursor composition. The particles contain the precursor starting materials intimately and essentially homogeneously mixed. The spray-dried particles appear to have the same uniform composition regardless of their size. In general, each of the particles contains all of the starting materials in the same proportion. Desirably the volatile constituent in the slurry is water. The spray drying may take place preferably in air or in an inert hot gas stream. A preferred hot drying gas is argon, though other inert gases may be used. The temperature at the gas of the outlet of the dryer is preferably greater than about 90-100° C. The inlet gas stream is at an elevated temperature sufficient to remove a major portion of the water with a reasonable drier volume, for a desired rate of dry powder production and particle size. Air inlet temperature, atomizer droplet size, and gas flow are factors which may be varied and affect the particle size of the spray dry product and the degree of drying. There may typically be some water or solvent left in the spray dried material. For example, there may be up to 5-15% by weight water. It is preferred that the drying step reduce the moisture content of the material to less than 10% by weight. The amount of solvent removed depends on the ratio of liquid flow to drying gas flow, residence time of the slurry droplets in contact with the heated air, and also depends on the temperature of the heated air.

Techniques for spray drying are well known in the art. In a non-limiting example, spray drying is carried out in a commercially available spray dryer such as an APV-Invensys PSD52 Pilot Spray Dryer. Typical operating conditions are in the following ranges: inlet temperature 250-350° C.; outlet temperature: 100-120° C.; feed rate: 4-8 liters (slurry) per hour.

The dried mixture is then optionally milled, mulled or milled and mulled for about 4 hours to about 24 hours, preferably from about 12 to about 24 hours and more preferably for about 12 hours. The amount of time required for milling is dependent on the intensity of the milling. For example, in small testing equipment the milling takes a longer period of time then is needed with industrial equipment.

In a final step of a preferred embodiment, active materials are prepared by heating the powdered precursor composition as described above for a time and at a temperature sufficient to form a reaction product. The powdered precursor composition may optionally be compressed into a pellet. The precursor composition is then heated (calcined) in an oven, generally at a temperature of about 400° C. or greater until the lithium vanadium phosphate reaction product forms.

It is preferred to heat the precursor composition at a ramp rate in a range from a fraction of a degree to about 20° C. per minute. However, one skilled in the art will recognize that the ramp rate could be about 100° C. per minute and that such ramp rates depend on reaction conditions. The ramp rate is to be chosen according to the capabilities of the equipment on hand and the desired turnaround or cycle time. As a rule, for faster turnaround it is preferred to heat up the sample at a relatively fast rate. High quality materials may be synthesized, for example, using ramp rates of 2° C./min, 4° C./min, 5° C./min and 10° C./min. Once the desired temperature is attained, the precursor composition is held at the reaction temperature for about 10 minutes to several hours, depending on the reaction temperature chosen. The heating may be conducted under an air atmosphere, or if desired may be conducted under a non-oxidizing or inert atmosphere or a reducing atmosphere as discussed earlier. After reaction, the products are cooled from the elevated temperature to ambient (room) temperature. The rate of cooling is selected depending on, among other factors, the capabilities of the available equipment, the desired turnaround time, and the effect of cooling rate on the quality of the active material. It is believed that most active materials are not adversely affected by a rapid cooling rate. The cooling may desirably occur at a rate of up to 50° C./minute or higher. Such cooling has been found to be adequate to achieve the desired structure of the final product in some cases. It is also possible to quench the products at a cooling rate on the order of about 100° C./minute. A generalized rate of cooling has not been found applicable for certain cases, therefore the suggested cooling requirements vary.

The precursor composition is heated at a temperature from about 400° C. to about 1000° C., preferably from about 700° C. to about 900° C. and more preferably at about 900° C. The heating period is from about 1 hour to about 24 hours and preferably from about 4 to about 16 hours and more preferably about 8 hours. The heating rate is typically about 2° C. per minute to about 5° C. per minute and preferably about 2° C. per minute.

The lithium vanadium phosphate material, produced by the above described method, is usable as electrode active material, for lithium ion (Li⁺) removal and insertion. These electrodes are combined with a suitable counter electrode to form a cell using conventional technology known to those with skill in the art. Upon extraction of the lithium ions from the lithium metal phosphates or lithium mixed metal phosphates, significant capacity is achieved.

The following is a list of some of the definitions of various terms used herein:

As used herein “battery” refers to a device comprising one or more electrochemical cells for the production of electricity. Each electrochemical cell comprises an anode, cathode, and an electrolyte.

As used herein the terms “anode” and “cathode” refer to the electrodes at which oxidation and reduction occur, respectively, during battery discharge. During charging of the battery, the sites of oxidation and reduction are reversed.

As used herein the tern “nominal formula” or “nominal general formula” refers to the fact that the relative proportion of atomic species may vary slightly on the order of 2 percent to 5 percent, or more typically, 1 percent to 3 percent.

As used herein the words “preferred” and “preferably” refer to embodiments of the invention that afford certain benefits under certain circumstances. Further the recitation of one or more preferred embodiments does not imply that other embodiments are not useful and is not intended to exclude other embodiments from the scope of the invention.

The following Examples are intended to be merely illustrative of the present invention, and not limiting thereof in either scope or spirit. Those with skill in the art will readily understand that known variations of the conditions and processes described in the Examples can be used to synthesize the compounds of the present invention.

Unless otherwise indicated all starting materials and equipment employed were commercially available.

### EXAMPLE 1

### Preparation of LVP by Wet Mixing

LiOH 2H₂O (250 g), V₂O₅ (357 g) H₃PO₄ (85%; 686 g), Super P (47 g), PEG 1450 (60 g) and H₂O (749+g) were mixed between 5 and 10 hours to form a slurry. The slurry was spray dried (250° C. in/120° C. out). The resulting precursor composition was calcined for 8 hours at 900° C. to produce lithium vanadium phosphate.

### EXAMPLE 2

### Preparation of LVP by Wet Mixing

LiOH 2H₂O (250 g), V₂O₅(357 g) H₃PO₄ (85%; 686 g), Super P (47 g), PEG 1450 (60 g) and H₂O (749+g) were mixed between 5 and 10 hours to form a slurry. The slurry was spray dried (250° C. in/120° C. out) and pelletized. The resulting precursor composition was calcined for 8 hours at 900° C. to produce lithium vanadium phosphate.

### EXAMPLE 3

### Preparation of LVP by Wet Mixing

LiOH 2H₂O (250 g), V₂O₅ (357 g) H₃PO₄ (85%; 686 g), Super P (47 g), PEG 1450 (60 g) and H₂O (749+g) were mixed between 5 and 10 hours to form a slurry. The slurry was spray dried (250° C. in/120° C. out). The resulting precursor composition was ball milled for 3 hours and then calcined for 8 hours at 900° C. to produce lithium vanadium phosphate.

### EXAMPLE 4

### Preparation of LVP by Wet Mixing

LiOH 2H₂O (250 g), V₂O₅ (357 g) H₃PO₄ (85%; 686 g), Super P (47 g), PEG 1450 (60 g) and H₂O (749+g) were mixed between 5 and 10 hours to form a slurry. The slurry was spray dried (250° C. in/120° C. out). The resulting precursor composition was ball milled for 3 hours and the pelletized. The pellet was calcined for 8 hours at 900° C. to produce lithium vanadium phosphate.

### EXAMPLE 5

### Preparation of LVP by Wet Mixing

LiOH 2H₂O (250 g), V₂O₅ (357 g) H₃PO₄ (85%; 686 g), Super P (47 g), PEG 1450 (60 g) and H₂O (749+g) were mixed between 5 and 10 hours to form a slurry. The slurry was spray dried (250° C. in/120° C. out). The resulting precursor composition was ball milled for 18 hours and then pelletized. The pellet was calcined for 8 hours at 900° C. to produce lithium vanadium phosphate.

### EXAMPLE 6

### Preparation of LVP by Wet Mixing

LiOH 2H₂O (250 g), V₂O₅ (357 g) H₃PO₄ (85%; 686 g), Super P (47 g), PEG 1450 (60 g) and H₂O (749+g) were mixed between 5 and 10 hours to form a slurry. The slurry was spray dried (250° C. in/120° C. out). The resulting precursor composition was calcined for 8 hours at 900° C. to produce lithium vanadium phosphate.

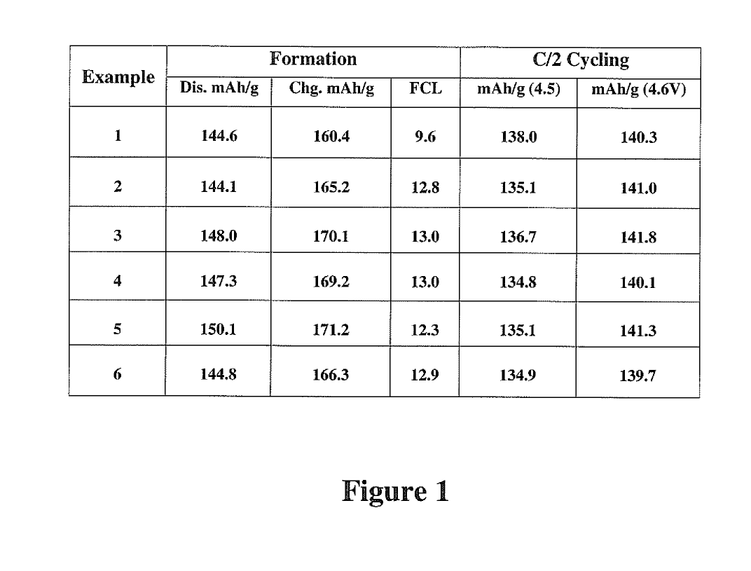

FIG. 1 shows the capacity data for the lithium vanadium phosphate so produced.

The compounds produced by the above described methodology find use as active materials for electrodes in ion batteries and more preferably in lithium ion batteries. The lithium vanadium phosphate produced by the present invention is useful as active material in electrodes of batteries, and more preferably are useful as active materials in positive electrodes (cathodes). When used in the positive electrodes of lithium ion batteries these active materials reversibly cycle lithium ions with the compatible negative electrode active material.

The active material of the compatible counter electrodes is any material compatible with the lithium vanadium phosphate of the present invention. The negative electrode can be made from conventional anode materials known to those skilled in the art. The negative electrode can be comprised of a metal oxide, particularly a transition metal oxide, metal chalcogenide, metal alloys, carbon, graphite, and mixtures thereof.

A typical laminated battery in which such material can be employed includes, but is not limited to batteries disclosed in the '033 patent. For example a typical bi-cell can comprise a negative electrode, a positive electrode and an electrolyte/separator interposed between the counter electrodes. The negative and positive electrodes each include a current collector. The negative electrode comprises an intercalation material such as carbon or graphite or a low voltage lithium insertion compound, dispersed in a polymeric binder matrix, and includes a current collector, preferably a copper collector foil, preferably in the form of an open mesh grid, embedded in one side of the negative electrode. A separator is positioned on the negative electrode on the side opposite of the current collector. A positive electrode comprising a metal phosphate or mixed metal phosphate of the present invention is positioned on the opposite side of the separator from the negative electrode. A current collector, preferably an aluminum foil or grid, is then positioned on the positive electrode opposite the separator. Another separator is positioned on the side opposite the other separator and then another negative electrode is positioned upon that separator. The electrolyte is dispersed into the cell using conventional methods. In an alternative embodiment two positive electrodes can be used in place of the two negative electrodes and then the negative electrode is replaced with a positive electrode. A protective bagging material can optionally cover the cell and prevent infiltration of air and moisture. U.S. Pat. No. 6,528,033 B1, Barker et al. is hereby incorporated by reference.

The electrochemically active compounds of the present invention can also be incorporated into conventional cylindrical electrochemical cells such as described in U.S. Pat. No. 5,616,436, U.S. Pat. No. 5,741,472 and U.S. Pat. No. 5,721,071 to Sonobe et al. Such cylindrical cells consist of a spirally coiled electrode assembly housed in a cylindrical case. The spirally coiled electrode assembly comprises a positive electrode separated by a separator from a negative electrode, wound around a core. The cathode comprises a cathode film laminated on both sides of a thick current collector comprising a foil or wire net of a metal.

An alternative cylindrical cell as described in U.S. Pat. No. 5,882,821 to Miyasaka can also employ the electrochemically active materials produced by the method of the present invention. Miyasaka discloses a conventional cylindrical electrochemical cell consisting of a positive electrode sheet and a negative electrode sheet combined via a separator, wherein the combination is wound together in spiral fashion. The cathode comprises a cathode film laminated on one or both sides of a current collector.

The active materials produced by the method of the present invention can also be used in an electrochemical cell such as described in U.S. Pat. No. 5,670,273 to Velasquez et al. The electrochemical cell described therein consists of a cathode comprising an active material, an intercalation based carbon anode, and an electrolyte there between. The cathode comprises a cathode film laminated on both sides of a current collector.

While this invention has been described in terms of certain embodiments thereof, it is not intended that it be limited to the above description. The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for making lithium vanadium phosphate comprising:
mixing a phosphate ion source, a lithium compound, V₂O₅, a polymeric material, solvent and a source of carbon or organic material to produce a slurry,
wet blending said slurry,
spray drying said wet blended slurry to produce a precursor composition; and
heating said precursor composition at a time and temperature sufficient to produce lithium vanadium phosphate.

2. The method according to claim 1 wherein the phosphate ion source is phosphoric acid.

3. The method according to claim 1 wherein the lithium compound is LiOH.

4. The method according to claim 2 wherein the lithium compound is LiOH.

5. The method according to claim 1 wherein the source of carbon is elemental carbon.

6. The method according to claim 2 wherein the source of carbon is elemental carbon.

7. The method according to claim 3 wherein the source of carbon is elemental carbon.

8. The method according to claim 4 wherein the source of carbon is elemental carbon.

9. The method according to claim 5 wherein the source of carbon is elemental carbon.

10. The method according to claim 1 wherein the polymeric material is selected from the group consisting of PEG and PEO.

11. the method according to claim 1 wherein the solvent is water

12. The method according to claim 1 wherein the precursor composition is ball milled prior to heating.

13. The method according to claim 12 wherein the ball milled precursor composition is pelletized prior to heating.

14. A method for producing lithium vanadium phosphate comprising:
reacting vanadium pentoxide with phosphoric acid to form a partially dissolved first slurry;
mixing said first slurry with an aqueous solution of lithium hydroxide to form a second slurry;
adding a polymeric material and a source of carbon to form a third slurry;
spray drying said slurry to form a precursor composition; and
heating said precursor composition at a time and temperature sufficient to produce lithium vanadium phosphate.

15. A method according to claim 14 wherein the precursor composition is ball milled prior to heating.

16. The method according to claim 15 wherein the precursor composition is pelletized prior to heating.

17. A method for producing lithium vanadium phosphate comprising:
Partially dissolving vanadium pentoxide in an aqueous solution of lithium hydroxide to form a first slurry;
adding phosphoric acid to said first slurry to form a second slurry;
adding a polymeric material and a source of carbon to said second slurry to form a third slurry;
spray drying said third slurry to form a precursor composition; and
heating said precursor composition at a time and temperature sufficient to produce lithium vanadium phosphate.

18. A method according to claim 17 wherein the precursor composition is ball milled prior to heating.

19. The method according to claim 18 wherein the precursor composition is pelletized prior to heating.

20. A cathode comprising lithium vanadium phosphate prepared according to claim 1.

21. A battery comprising a cathode according to claim 20.
